(19) United States
(12) Patent Application Publication
(10) Pub. No.: US 2012/0091126 A1
(43) Pub. Date: Apr. 19, 2012

(54) Microwave Heating Apparatus for Food Item with Curved Surface

(76) Inventor: Kelly R. Fitzwater, Lakewood, CO (US)

(21) Appl. No.: 13/271,360

(22) Filed: Oct. 12, 2011

Related U.S. Application Data
(60) Provisional application No. 61/455,294, filed on Oct. 18, 2010.

(51) Int. Cl. H05B 6/80; B65D 25/00

(52) U.S. Cl. 219/730; 220/62; 219/759

(57) ABSTRACT

A microwave heating construct includes a substantially tubular body having a pair of open ends and an interior space for receiving a food item. The body comprises a plurality of foldably joined panel segments extending between the open ends of the body, and microwave energy interactive material operative for converting at least a portion of impinging microwave energy into thermal energy. A plurality of support elements may extend downwardly from the body.

### CROSS-REFERENCE TO RELATED APPLICATION

This application claims the benefit of U.S. Provisional Application No. 61/455,294, filed Oct. 18, 2010, which is incorporated by reference herein in its entirety.

### TECHNICAL FIELD

This disclosure relates to an apparatus or construct for heating or cooking a microwavable food item. In particular, this disclosure relates to an apparatus or construct for heating or cooking a food item in a microwave oven, where the food item has a curved surface that is desirably browned and/or crisped.

### BACKGROUND

Microwave ovens provide a convenient means for heating a variety of food items, including sandwiches and other bread and/or dough-based products such as pizzas and pies. However, microwave ovens tend to cook such items unevenly and are unable to achieve the desired balance of thorough heating and a browned, crisp crust, particularly where the food item has a curved or irregular shape. As such, there is a continuing need for improved materials, packages, and constructs that provide the desired degree of heating, browning, and/or crisping of various food items in a microwave oven.

### SUMMARY

This disclosure is directed to construct or apparatus for heating, browning, and/or crisping a food item in a microwave oven, and a blank for forming the construct. The construct includes a somewhat tubular shaped body or portion having an interior space for receiving a generally curved food item. The construct also may include one or more features that maintain the tubular body in an elevated condition.

If desired, microwave energy interactive material configured as one or more microwave energy interactive elements may overlie the interior side of the tubular body or any other portion of the construct to alter the effect of microwave energy on the food item. In one example, the microwave energy interactive element may comprise a susceptor, i.e., a thin layer of microwave energy interactive material generally less than about 100 angstroms in thickness, for example, from about 60 to about 100 angstroms in thickness, and having an optical density of 0.15 to about 0.35, for example, about 0.17 to about 0.28. When sufficiently exposed to microwave energy, the susceptor tends to absorb at least a portion of the microwave energy and convert it to thermal energy (i.e., heat) through resistive losses in the layer of microwave energy interactive material. The remaining microwave energy is either reflected by or transmitted through the susceptor. Susceptors often are used to promote browning and/or crisping of the surface of a food item. However, other microwave energy interactive elements may be used.

The construct may be used to prepare various food items in a microwave oven, for example, pizza rolls, egg rolls, savory or sweet pastries, breaded food items, or any other generally tubular food item that desirably is heated, browned, and/or crisped.

The construct may generally be formed from a disposable material, for example, paperboard. The construct also may be used in a conventional oven.

Additional aspects, features, and advantages of the present invention will become apparent from the following description and accompanying figures.

### BRIEF DESCRIPTION OF THE DRAWINGS

The description refers to the accompanying schematic drawings in which like reference characters refer to like parts throughout the several views, and in which:

FIG. 1A is a schematic top plan view of one side of an exemplary blank for forming a microwave heating construct;

FIG. 1B is a schematic cross-sectional view of the exemplary blank of FIG. 1A, taken along a line 1B-1B; and

FIGS. 1C and 1D schematically depict alternate perspective views of an exemplary microwave heating construct.

### DESCRIPTION

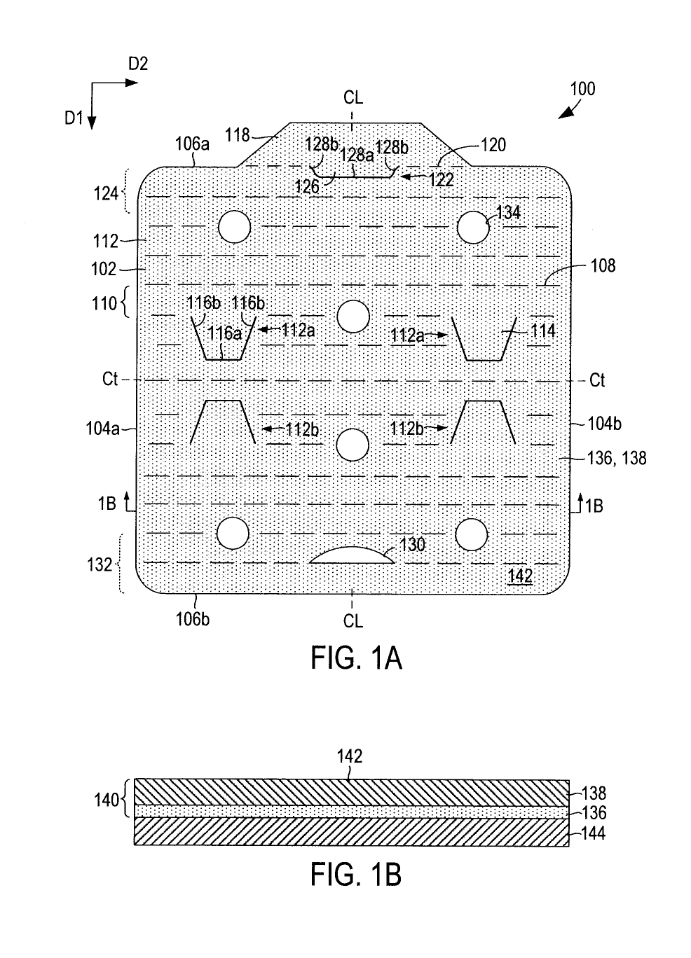

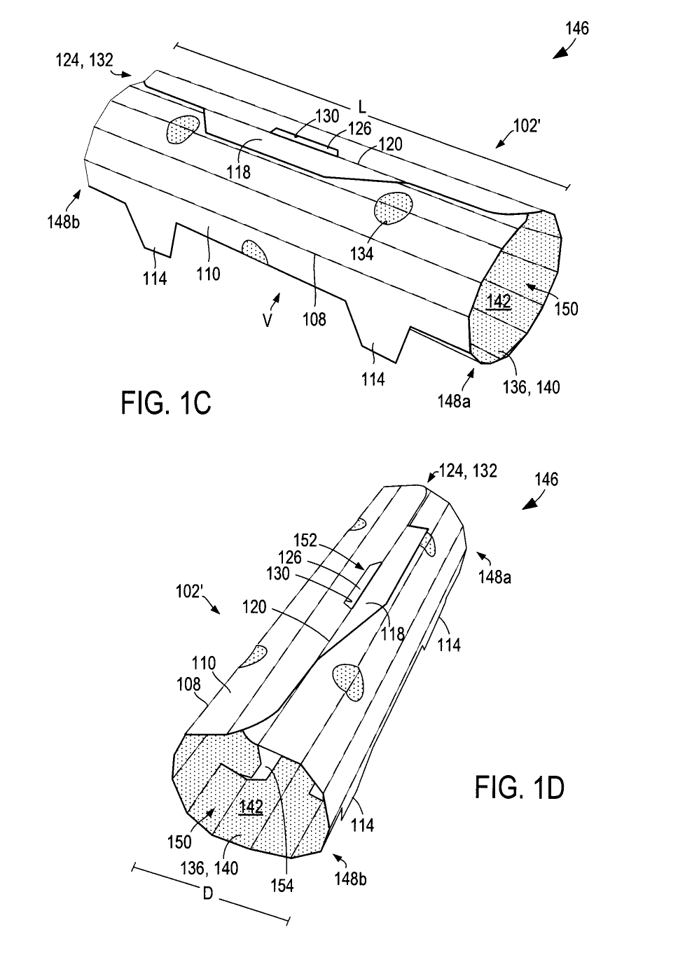

FIG. 1A depicts a schematic top plan view of one side of an exemplary blank 100 that may be used to form a microwave heating construct 146 (FIGS. 1C and 1D). The blank 100 generally includes a plurality of panels or portions joined along lines of weakening or disruption, for example, fold lines, tear lines, score lines, cut-crease lines, cut-space lines, or any other lines of weakening or disruption, or any combination thereof. The blank 100 and each of the various panels or portions generally has a first dimension, for example, a length, extending in a first direction, for example, a longitudinal direction, D1, and a second dimension, for example, a width, extending in a second direction, for example, a transverse direction, D2. It will be understood that such designations are made only for convenience and do not necessarily refer to or limit the manner in which the blank is manufactured or erected into the construct. The blank 100 may be symmetric or nearly symmetric about a longitudinal centerline CL. Therefore, certain elements in the drawing figures may have similar or identical reference numerals to reflect the whole or partial symmetry.

As shown in FIG. 1A, the blank 100 generally includes a panel (e.g., a main panel or first panel) 102 having a plurality of peripheral edges or side edges including a first edge 104a and a second edge 104a (e.g., a first pair of opposed edges or pair of longitudinal edges) extending substantially in the first direction D1, and a third edge 106a and a fourth edge 106b (e.g., a second pair of opposed edges or pair of transverse edges) extending substantially in the second direction D2. The first pair of edges 104a, 104b and second pair of edges 106a, 106b are substantially equal in length, so that the main panel 102 has a substantially square shape. However, countless other shapes may be used. Additionally, in this example, the main panel 102 has somewhat rounded corners, but square corners may be used if desired. The main panel 102 generally includes a longitudinal centerline extending substantially along the longitudinal centerline CL of the blank 100 and a transverse centerline Ct extending in a direction substantially perpendicular to the longitudinal centerline CL.

A plurality of transverse lines of disruption 108 (only one of which is labeled) extend at least partially (and in some cases substantially) across the main panel 102 to define a plurality of panel segments 110 (only one of which is labeled) that are foldably joined to one another along lines of disruption 108. In this example, each line of disruption 108 comprises a cut-space line, that is, a plurality of spaced apart creases or partial depth cuts. However, any type of line of disruption or weakening may be used, for example, fold lines, score lines, cut-crease lines, or otherwise.

The main panel 102 also includes a plurality of cuts, for example, somewhat U-shaped cuts 112a, 112b (e.g., slits or cutouts) that generally define support elements 114 in the erected construct 146 (FIGS. 1C and 1D). More particularly, in this example, the main panel 102 includes two pairs of cuts 112a, 112b (e.g., a first pair of cuts 112a and a second pair of cuts 112b) positioned as mirror images on opposite sides of the transverse centerline Ct distal from the first side edge 104a and the second side edge 104b of the panel 102. Each cut 112a, 112b includes a transverse portion 116a and a pair of portions 116b that extend away from ends of the transverse portion 116a. In this example, portions 116b comprise oblique portions 116b that extend obliquely away from ends of the transverse portion 116a, so that the resulting support elements 114 have a generally trapezoidal shape (FIGS. 1C and 1D). Further, the transverse portion 116a of each cut 112a, 112b is disposed proximate to the transverse centerline Ct, so that the transverse portions 116a of the pairs of cuts 112a, 112b are facing one another, with the oblique portions 116b extending in a direction generally away from the each other and away from the transverse centerline Ct. However, other configurations of cuts 112a, 112b are contemplated. For example, in one embodiment (not shown), the oblique portions 116b may extend obliquely towards one another. In yet another embodiment (not shown), portions 116b may comprise longitudinal portions, so that the resulting support elements 114 (FIGS. 1C and 1D) have a rectangular shape. Still other possibilities are contemplated.

Still viewing FIG. 1A, the blank 100 also includes a minor panel or projection 118 extending from the third edge 106a (i.e., one of the transverse edges) of the main panel 102 along a line of disruption 120, for example, cut-space line 120, which may be generally collinear with the third edge 106a of the main panel 102. In other examples, line of disruption 120 may be a fold line, cut-crease line, or otherwise. The minor panel 118 is generally trapezoidal in shape, with a transverse dimension that decreases moving away from cut-space line 120, so that the widest portion of the minor panel or projection 118 is adjacent to the main panel 102. However, differently shaped projections may be used. The minor panel or projection 118 defines a grasping feature 118 in the erected construct 146 (FIGS. 1C and 1D), as will be discussed further below.

The blank 100 also includes a cut (e.g., slit or cutout), for example, a somewhat U-shaped cut 122, generally disposed within a peripheral margin (e.g., a first peripheral margin or transverse marginal area, generally indicated at 124) of the main panel 102 adjacent to the third peripheral edge 106a. Cut 122 generally defines a locking feature or tab 126 in the erected construct 146 (FIGS. 1C and 1D).

The cut 122 includes a transverse portion 128a and a pair of oblique portions 128b that extend inwardly towards each other in a direction towards the transverse centerline Ct. The endpoints of the cut 122 (e.g., the endpoints of the oblique portions 128b of the cut 122 may generally be proximate to the third side edge 106a of the main panel 102, and in this example, the endpoints of the cut 122 are proximate to and/or extend substantially from cut-space line 120 into the main panel 102. However, in other embodiments (not shown), the endpoints of cut 122 may be distanced from cut-space line 120.

In the illustrated embodiment, the resulting locking feature or tab 126 has a substantially trapezoidal shape; however, in embodiments (not shown) the oblique portions 128b of cut 122 may be replaced with longitudinal portions, so that the resulting locking tab 126 (FIGS. 1C and 1D) has a rectangular shape. Still other possibilities are contemplated.

The blank 100 also includes a cut (e.g., slit or cutout) 130 generally disposed within a peripheral margin (e.g., a second peripheral margin or transverse marginal area, generally indicated at 132) of the main panel 102 adjacent to the fourth edge 106b. Cutout 130 may be substantially aligned in the second direction with cut 122 so that cutout 130 generally defines a receiving slot 130 for locking tab 126 in the erected construct 146 (FIGS. 1C and 1D). In this example, cutout 130 has a somewhat semi-circular shape, but differently shaped cutouts 130 may be used.

The main panel 102 also includes a plurality of apertures or cutouts 134 (only one of which is labeled) extending through the thickness of the blank 100. In this example, two apertures 134 are positioned substantially along the longitudinal centerline CL and four apertures 134 located generally proximate to each of the four corners of the main panel 102. In the illustrated embodiment, the apertures 134 are substantially circular in shape. However, other numbers, shapes, and arrangements of apertures are contemplated.

If desired, the blank may include microwave energy interactive material (shown schematically with stippling) configured as one or more microwave energy interactive elements 136 that alter the effect of microwave energy on an adjacent food item. For example, the microwave energy interactive material may be configured as a susceptor operative for converting at least a portion of impinging microwave energy into thermal energy (i.e., heat).

In this example, the microwave energy interactive material (e.g., susceptor) 136 overlies and/or is joined to all or a portion of the main panel 102. In this example, the susceptor 136 overlies substantially the entire main panel 102 except where the apertures 134 are present. However, in other embodiments, the microwave energy interactive material may overlie only a portion of panel 102. Additionally, in this example, the susceptor also overlies minor panel or projection 118. However, in other embodiments, the microwave energy interactive material 136 may be configured to overlie only the main panel 102, such that the minor panel or projection 118 is microwave energy transparent or inactive.

As shown in FIG. 1B, the microwave energy interactive material (i.e., susceptor) 136 may be supported on a polymer film 138 to define a susceptor film 140. The outermost surface (i.e., the exposed surface) 142 of the polymer film 138 may serve as a food-contacting surface of the construct 146 (i.e., for being in facing, substantially contacting relationship with the food item) erected from the blank 100 (FIG. 1A). The susceptor film 140 may be joined (e.g., laminated) to a support layer 144, for example, paper or paperboard, using an adhesive or otherwise (not shown), to impart dimensional stability to the susceptor film 140 and to protect the layer of microwave energy interactive material 130 from being damaged.

To form the microwave heating construct 146 (FIGS. 1C and 1D) from the blank 100 according to one acceptable method, minor panel 118 and side edge 106b may be brought towards one another until the peripheral margins 124, 132 of the main panel 102 are overlapped slightly. In doing so, the various foldably joined panel segments 110 may be folded along lines of disruption 108 so that the main panel 102 forms a substantially tubular body 102′ having a pair of open ends 148a, 148b (defined by longitudinal side edges 104a, 104b of blank 100) with the lines of disruption 108 extending along a length L of the body 102′ substantially between the open ends 148a, 148b. The tubular body or portion 102′ of the construct 100 defines an interior space 150 for receiving a food item (not shown). The microwave energy interactive material (shown schematically with stippling), for example, susceptor 136 (e.g., provided on a polymer film 138 to form a susceptor film 140) may be disposed on a side of the main panel 102 facing the interior space 150 of the body 102′, so that the outermost surface 142 of the susceptor film 140 is for contacting the food item, and the microwave energy interactive material 136 is for being generally being proximate and/or adjacent to the food item.

Locking tab 126 may then be engaged with (e.g., inserted into) cutout 130, as shown in FIGS. 1C and 1D to define a locking or fastening assembly or feature 152 for releasably securing the marginal areas 124, 132 to one another and to maintain the body 102′ in a substantially tubular configuration. When the locking tab 126 is engaged with the cutout 130, the locking tab is at least partially disposed within the interior space 150 of the body 102′.

Minor panel 118 serves as a grasping feature or projection 118 that can be pivoted along cut-space line 120 to facilitate insertion of the locking tab 126 into the cutout 130. In the locked configuration, the grasping feature or projection 118 ma extend outwardly, and in some cases, obliquely, from an upper portion of the body 102′ proximate to the locking tab 126. In this example, the grasping feature 118 generally “points” in the opposite direction from the locking tab 126 (i.e., grasping feature 118 and tab 126 taper in directions that are opposite one another). However, other configurations are contemplated.

As the tubular body 102′ is formed, support elements 114 are struck from the main panel 102 adjacent to cuts 112a, 112b and brought into a generally upright configuration beneath the tubular body 102′. The elevating features or feet 114 may extend downwardly from the lower portion of the tubular body 102′ (and along the length L of body 102′) so that the support elements 114 define a void V beneath the body 102′ (e.g., when the body 102′ is positioned substantially parallel to a floor of a microwave oven). In this example, the construct 100 includes four elevating features 114 (only three of which are visible in FIGS. 1C and 1D) that are substantially trapezoidal in shape. However, any number and shape of elevating features may be used.

When support elements 114 are struck from the main panel 102, an aperture 154 is defined adjacent to each support element 114 (FIG. 1D). Such apertures 154 may serve as venting and/or draining apertures during heating. Additionally, apertures 134 may likewise carry moisture away from the food item during heating, as will be discussed below.

To use the construct 146 according to one acceptable method, a food item may be placed into the interior space 150 within the tubular body 102′, or alternatively, the construct 146 may be erected “around” the food item, so that the main panel 102 enwraps the food item as the tubular body 102′ is formed. Upon sufficient exposure to microwave energy, the microwave energy interactive material (i.e., susceptor 136) converts at least a portion of the impinging microwave energy into thermal energy, which then may be transferred to the surface of the food item within the interior space 150. As a result, the heating, browning, and/or crisping of the food item may be enhanced. Notably, by providing the tubular shape of the body 102′, the top, bottom, and sides of a rounded food item can be heated, browned, and/or crisped concurrently without having to instruct the user to reposition the food item during the heating cycle.

Any water vapor generated during heating may be carried away from the food item through the open ends 148a, 148b of the tubular body 102′ and the venting apertures 134, 154 thereby further enhancing the browning and/or crisping of the food item. Further, the void V beneath the construct 100 that may provide an insulating effect, thereby decreasing the amount of heat loss from the susceptor 136 to the floor of the microwave oven. As a result, the heating of the food item and the browning and/or crisping of the surface of the food item may be enhanced further.

After heating, the food item may be removed through one of the open ends 148a, 148b of the construct 146. Alternatively, the grasping tab 118 may be grasped to release the locking tab 126 from cutout 130, thereby allowing the tubular portion 102′ of the construct 100 to be opened to provide access to the food item.

It will be noted that the blank 100 and construct 146 may generally be dimensioned and/or configured so that the susceptor 136 (or other microwave energy interactive element) is proximate to the area to be heated, browned, and/or crisped. Thus, for example, when a food item to be heated has a generally tubular shape with a particular length and diameter, the main panel 102 may be dimensioned so that the length L and/or diameter D of the resulting tubular body 102′ is slightly larger than the length and/or diameter of the food item. Also, it will be noted that, when viewed in cross-section, the tubular body 102′ of the illustrated embodiment may generally have a polygonal shape. However, it will be appreciated that fewer or more lines of disruption 110 may be used, and that the more lines used, the more the shape of the body 102′ will approach a more smoothly rounded (e.g., circular) or curved tubular shape (which brings more of the microwave energy interactive material into even closer proximity with the surface of the food item). Such a shape may be particularly useful for containing a more curved food item, for example, a corn dog, egg roll, or stuffed breadstick.

Numerous microwave heating constructs are encompassed by the disclosure. Any of such structures or constructs may be formed from various materials, provided that the materials are substantially resistant to softening, scorching, combusting, or degrading at typical microwave oven heating temperatures, for example, at from about 250° F. to about 425° F. The materials may include microwave energy interactive materials, for example, those used to form susceptors (e.g., susceptor 136) and other microwave energy interactive elements, and microwave energy transparent or inactive materials, for example, those used to form the remainder of the construct.

The microwave energy interactive material may be an electroconductive or semiconductive material, for example, a vacuum deposited metal or metal alloy, or a metallic ink, an organic ink, an inorganic ink, a metallic paste, an organic paste, an inorganic paste, or any combination thereof. Examples of metals and metal alloys that may be suitable include, but are not limited to, aluminum, chromium, copper, inconel alloys (nickel-chromium-molybdenum alloy with niobium), iron, magnesium, nickel, stainless steel, tin, titanium, tungsten, and any combination or alloy thereof.

Alternatively, the microwave energy interactive material may comprise a metal oxide, for example, oxides of aluminum, iron, and tin, optionally used in conjunction with an electrically conductive material. Another metal oxide that may be suitable is indium tin oxide (ITO). ITO has a more uniform crystal structure and, therefore, is clear at most coating thicknesses.

Alternatively still, the microwave energy interactive material may comprise a suitable electroconductive, semiconductive, or non-conductive artificial dielectric or ferroelectric. Artificial dielectrics comprise conductive, subdivided material in a polymeric or other suitable matrix or binder, and may include flakes of an electroconductive metal, for example, aluminum.

In other embodiments, the microwave energy interactive material may be carbon-based, for example, as disclosed in U.S. Pat. Nos. 4,943,456, 5,002,826, 5,118,747, and 5,410,135.

In still other embodiments, the microwave energy interactive material may interact with the magnetic portion of the electromagnetic energy in the microwave oven. Correctly chosen materials of this type can self-limit based on the loss of interaction when the Curie temperature of the material is reached. An example of such an interactive coating is described in U.S. Pat. No. 4,283,427.

As stated above, the microwave energy interactive material (e.g., microwave energy interactive material 136) may be supported on a polymer film (e.g., polymer film 138). The thickness of the film typically may be from about 35 gauge to about 10 mil, for example, from about 40 to about 80 gauge, for example, from about 45 to about 50 gauge, for example, about 48 gauge. Examples of polymer films that may be suitable include, but are not limited to, polyolefins, polyesters, polyamides, polyimides, polysulfones, polyether ketones, cellophanes, or any combination thereof. In one specific example, the polymer film may comprise polyethylene terephthalate (PET). Examples of PET films that may be suitable include, but are not limited to, MELINEX®, commercially available from DuPont Teijan Films (Hopewell, Va.), SKYROL, commercially available from SKC, Inc. (Covington, Ga.), and BARRIALOX PET, available from Toray Films (Front Royal, Va.), and QU50 High Barrier Coated PET, available from Toray Films (Front Royal, Va.). The polymer film may be selected to impart various properties to the microwave interactive web, for example, printability, heat resistance, or any other property. As one particular example, the polymer film may be selected to provide a water barrier, oxygen barrier, or any combination thereof. Such barrier film layers may be formed from a polymer film having barrier properties or from any other barrier layer or coating as desired. Suitable polymer films may include, but are not limited to, ethylene vinyl alcohol, barrier nylon, polyvinylidene chloride, barrier fluoropolymer, nylon 6, nylon 6,6, coextruded nylon 6/EVOH/nylon 6, silicon oxide coated film, barrier polyethylene terephthalate, or any combination thereof.

If desired, the polymer film may undergo one or more treatments to modify the surface prior to depositing the microwave energy interactive material onto the polymer film. By way of example, and not limitation, the polymer film may undergo a plasma treatment to modify the roughness of the surface of the polymer film. While not wishing to be bound by theory, it is believed that such surface treatments may provide a more uniform surface for receiving the microwave energy interactive material, which in turn, may increase the heat flux and maximum temperature of the resulting susceptor structure. Such treatments are discussed in U.S. Patent Application Publication No. 2010/0213192 A1, published Aug. 26, 2010, which is incorporated by reference herein in its entirety.

Other non-conducting substrate materials such as paper and paper laminates, metal oxides, silicates, cellulosics, or any combination thereof, also may be used.

If desired, the susceptor may be used in conjunction with other microwave energy interactive elements and/or structures. Structures including multiple susceptor layers are also contemplated.

By way of example, the susceptor may be used with a foil or high optical density evaporated material having a thickness sufficient to reflect a substantial portion of impinging microwave energy. Such elements typically are formed from a conductive, reflective metal or metal alloy, for example, aluminum, copper, or stainless steel, in the form of a solid “patch” generally having a thickness of from about 0.000285 inches to about 0.005 inches, for example, from about 0.0003 inches to about 0.003 inches. Other such elements may have a thickness of from about 0.00035 inches to about 0.002 inches, for example, 0.0016 inches.

In some cases, microwave energy reflecting (or reflective) elements may be used as shielding elements where the food item is prone to scorching or drying out during heating. In other cases, smaller microwave energy reflecting elements may be used to diffuse or lessen the intensity of microwave energy. One example of a material utilizing such microwave energy reflecting elements is commercially available from Graphic Packaging International, Inc. (Marietta, Ga.) under the trade name MicroRite® packaging material. In other examples, a plurality of microwave energy reflecting elements may be arranged to form a microwave energy distributing element to direct microwave energy to specific areas of the food item. If desired, the loops may be of a length that causes microwave energy to resonate, thereby enhancing the distribution effect. Examples of microwave energy distributing elements are described in U.S. Pat. Nos. 6,204,492, 6,433,322, 6,552,315, and 6,677,563.

In still another example, the susceptor may be used with or may be used to form a microwave energy interactive insulating material. Examples of such materials are provided in U.S. Pat. No. 7,019,271, U.S. Pat. No. 7,351,942, and U.S. Patent Application Publication No. 2008/0078759 A1, published Apr. 3, 2008.

If desired, any of the numerous microwave energy interactive elements described herein or contemplated hereby may be substantially continuous, that is, without substantial breaks or interruptions, or may be discontinuous, for example, by including one or more breaks or apertures that transmit microwave energy. The breaks or apertures may extend through the entire structure, or only through one or more layers. The number, shape, size, and positioning of such breaks or apertures may vary for a particular application depending on the type of construct being formed, the food item to be heated therein or thereon, the desired degree of heating, browning, and/or crisping, whether direct exposure to microwave energy is needed or desired to attain uniform heating of the food item, the need for regulating the change in temperature of the food item through direct heating, and whether and to what extent there is a need for venting.

By way of illustration, a microwave energy interactive element may include one or more transparent areas to effect dielectric heating of the food item. However, where the microwave energy interactive element comprises a susceptor, such apertures decrease the total microwave energy interactive area, and therefore, decrease the amount of microwave energy interactive material available for heating, browning, and/or crisping the surface of the food item. Thus, the relative amounts of microwave energy interactive areas and microwave energy transparent areas must be balanced to attain the desired overall heating characteristics for the particular food item.

As another example, one or more portions of the susceptor may be designed to be microwave energy inactive to ensure that the microwave energy is focused efficiently on the areas to be heated, browned, and/or crisped, rather than being lost to portions of the food item not intended to be browned and/or crisped or to the heating environment. Additionally or alternatively, it may be beneficial to create one or more discontinuities or inactive regions to prevent overheating or charring of the food item and/or the construct including the susceptor. By way of example, the susceptor may incorporate one or more “fuse” elements that limit the propagation of cracks in the susceptor structure, and thereby control overheating, in areas of the susceptor structure where heat transfer to the food is low and the susceptor might tend to become too hot. The size and shape of the fuses may be varied as needed. Examples of susceptors including such fuses are provided, for example, in U.S. Pat. No. 5,412,187, U.S. Pat. No. 5,530,231, U.S. Patent Application Publication No. US 2008/0035634A1, published Feb. 14, 2008, and PCT Application Publication No. WO 2007/127371, published Nov. 8, 2007.

In the case of a susceptor, any of such discontinuities or apertures may comprise a physical aperture or void in one or more layers or materials used to form the structure or construct, or may be a non-physical “aperture”. A non-physical aperture is a microwave energy transparent area that allows microwave energy to pass through the structure without an actual void or hole cut through the structure. Such areas may be formed by simply not applying microwave energy interactive material to the particular area, by removing microwave energy interactive material from the particular area, or by mechanically deactivating the particular area (thereby rendering the area electrically discontinuous). Alternatively, the areas may be formed by chemically deactivating the microwave energy interactive material in the particular area, thereby transforming the microwave energy interactive material in the area into a substance that is transparent to microwave energy (i.e., microwave energy inactive). While both physical and non-physical apertures allow the food item to be heated directly by the microwave energy, a physical aperture also provides a venting function to allow steam or other vapors or liquid released from the food item to be carried away from the food item.

As stated above, the susceptor film (e.g., susceptor film 140) (and/or other microwave energy interactive elements) may be joined to a paper or paperboard support (e.g., support 144) that may impart dimensional stability to the structure. The paper may have a basis weight of from about 15 to about 60 lb/ream (lb/3000 sq. ft.), for example, from about 20 to about 40 lb/ream, for example, about 25 lb/ream. The paperboard may have a basis weight of from about 60 to about 330 lb/ream, for example, from about 80 to about 140 lb/ream. The paperboard generally may have a thickness of from about 6 to about 30 mils, for example, from about 12 to about 28 mils. In one particular example, the paperboard has a thickness of about 14 mils. Any suitable paperboard may be used, for example, a solid bleached sulfate board, for example, Fortress® board, commercially available from International Paper Company, Memphis, Tenn., or solid unbleached sulfate board, such as SUS® board, commercially available from Graphic Packaging International, Marietta, Ga.

While the present invention is described herein in detail in relation to specific aspects and embodiments, it is to be understood that this detailed description is only illustrative and exemplary of the present invention and is made merely for purposes of providing a full and enabling disclosure of the present invention and to set forth the best mode of practicing the invention known to the inventors at the time the invention was made. The detailed description set forth herein is illustrative only and is not intended, nor is to be construed, to limit the present invention or otherwise to exclude any such other embodiments, adaptations, variations, modifications, and equivalent arrangements of the present invention. All directional references (e.g., upper, lower, upward, downward, left, right, leftward, rightward, top, bottom, above, below, vertical, horizontal, clockwise, and counterclockwise) are used only for identification purposes to aid the reader's understanding of the various embodiments of the present invention, and do not create limitations, particularly as to the position, orientation, or use of the invention unless specifically set forth in the claims. Joinder references (e.g., joined, attached, coupled, connected, and the like) are to be construed broadly and may include intermediate members between a connection of elements and relative movement between elements. As such, joinder references do not necessarily imply that two elements are connected directly and in fixed relation to each other. Further, various elements discussed with reference to the various embodiments may be interchanged to create entirely new embodiments coming within the scope of the present invention.

What is claimed is:

1. A microwave heating construct, comprising:
a substantially tubular body having a pair of open ends and an interior space for receiving a food item, the body comprising a plurality of foldably joined panel segments extending between and at least partially defining the open ends of the body, wherein the body includes microwave energy interactive material, the microwave energy interactive material being operative for converting at least a portion of impinging microwave energy into thermal energy; and
a plurality of support elements extending downwardly from the body.

2. The construct of claim 1, wherein the body comprises a pair of overlapping marginal areas extending between the open ends of the body.

3. The construct of claim 2, wherein the pair of overlapping marginal areas are releasably secured to one another.

4. The construct of claim 3, wherein
the pair of overlapping marginal areas includes a first marginal area and a second marginal area
the first marginal area includes a locking tab,
the second marginal area includes a cutout, and
the locking tab of the first marginal area is engaged with the cutout of the second marginal area.

5. The construct of claim 4, wherein the locking tab is at least partially disposed within the interior space of the body.

6. The construct of claim 4, further comprising a grasping feature adjacent to the first marginal area, wherein the grasping feature extends oppositely from the locking tab.

7. The construct of claim 6, wherein the grasping feature extends obliquely from the body.

8. The construct of claim 1, wherein the plurality of foldably joined panel segments are joined to one another along fold lines extending between the open ends of the body.

9. The construct of claim 1, wherein the open ends of the body define opposite ends of a length of the body, and the support elements extend downwardly from the body along the length of the body.

10. The construct of claim 9, wherein the support elements extend downwardly from the body along the length of the body so that the length of the body is for being positioned substantially parallel to a floor of a microwave oven.

11. The construct of claim 1, wherein the support elements define a void beneath the body.

12. The construct of claim 1, further comprising an aperture adjacent to each support element.

13. A blank for forming a microwave heating construct, comprising:
a panel including a first dimension extending in a first direction and a second dimension extending in a second direction, the first direction being substantially perpendicular to the second direction, wherein the panel includes
a first edge and a second edge extending in the first direction,
a plurality of lines of disruption extending substantially from the first edge to the second edge,
a plurality of generally U-shaped cuts, the cuts each including a transverse portion that extends in the second direction and a pair of portions that extend away from the transverse portion, wherein the first pair of cuts and the second pair of cuts are arranged so that the transverse portion of the cuts are in a facing relationship with one another; and
microwave energy interactive material joined to the panel, the microwave energy interactive material being operative for converting at least a portion of impinging microwave energy to heat.

14. The blank of claim 13, wherein the pair of portions that extend away from the transverse portion comprise oblique portions extend obliquely away from the transverse portion.

15. The blank of claim 13, wherein the plurality of generally U-shaped cuts are distal from the first side edge and the second side edge of the panel.

16. The blank of claim 13, wherein
the panel includes a centerline extending in the second direction, and
the first pair of cuts and the second pair of cuts are disposed on opposite sides of the centerline.

17. The blank of claim 13, wherein the panel includes
a third edge and a fourth edge extending in the second direction,
a first cut disposed proximate to the third edge, and
a second cut disposed proximate to the fourth edge.

18. The blank of claim 17, wherein
the first cut is a generally U-shaped cut having endpoints proximate to the third edge, and
the second cut comprises a cutout, the cutout being substantially aligned in the second direction with the first cut.

19. The blank of claim 18, wherein the cutout is substantially semi-circular in shape.

20. The blank of claim 13, wherein
the panel is a main panel, and
the construct further comprises a minor panel joined to the main panel along the third edge of the main panel.

21. The blank of claim 20, wherein the minor panel has a substantially trapezoidal shape.

22. A microwave heating construct, comprising:
a substantially tubular body having opposite ends and an interior space for receiving a food item, wherein the body includes microwave energy interactive material, and the microwave energy interactive material is operative for converting at least a portion of impinging microwave energy into thermal energy; and
a plurality of support elements extending downwardly from the body.

23. The construct of claim 22, wherein the support elements are struck from the body.

24. The construct of claim 22, wherein
the opposite ends are open, and
the body comprises a plurality of foldably joined panel segments extending between and at least partially defining the open ends of the body.
